(19) United States
(12) Patent Application Publication
(10) Pub. No.: US 2015/0132617 A1
(43) Pub. Date: May 14, 2015

(54) SEALED BATTERY WITH LIQUID CRYSTAL DISPLAY

(71) Applicant: Dale Petruzzi, Carmel, IN (US)

(72) Inventor: Dale Petruzzi, Carmel, IN (US)

(73) Assignee: J-J.A.D.E. ENTERPRISE LLC, Carmel, IN (US)

(21) Appl. No.: 14/087,089

(22) Filed: Nov. 22, 2013

Related U.S. Application Data
(60) Provisional application No. 61/902,240, filed on Nov. 10, 2013.

(51) Int. Cl. H01M 10/48; H01M 10/06; H01M 2/12

(52) U.S. Cl. CPC H01M 10/488; H01M 2/12; H01M 10/06; H01M 2220/20
USPC 429/53; 429/90; 429/93

(57) ABSTRACT

A battery is disclosed that includes a sealed case. A plurality of cells are positioned in the sealed case. A controller is connected with and powered by the cells. A display is connected with the controller and mounted on the case. The controller is configured to monitor at least one state of the battery, wherein the at least one state comprises a voltage level state of the battery. The controller is configured to display the voltage level state on the display.

### CROSS REFERENCE TO RELATED APPLICATIONS

This application claims priority to and the benefit of U.S. Provisional Application Ser. No. 61/902,240 filed on Nov. 10, 2013.

### BACKGROUND OF THE INVENTION

Traditional lead acid batteries are made up of plates, lead, and lead oxide with a 35% sulfuric acid and 65% water solution. This solution is called an electrolyte which causes a chemical reaction that produces electrons. A problem with wet-seal lead acid batteries is that over time the electrolyte causes corrosion. In addition, if the battery is damaged or a crack is caused in the case the electrolyte leaks out and can be harmful to the environment. Further, traditional batteries for vehicles do not include an indicator that allows the operator to know the condition of the battery. As such, a need exists for a battery that does not leak electrolyte and is capable of indicating the state of the battery to the user.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 illustrates a sealed battery having a liquid crystal display.

FIG. 2 illustrates a component view of the battery illustrated in FIG. 1.

FIG. 3 illustrates settings capable of being displayed on the liquid crystal display.

FIG. 4 illustrates further settings capable of being displayed on the liquid crystal display.

### DETAILED DESCRIPTION OF THE INVENTION

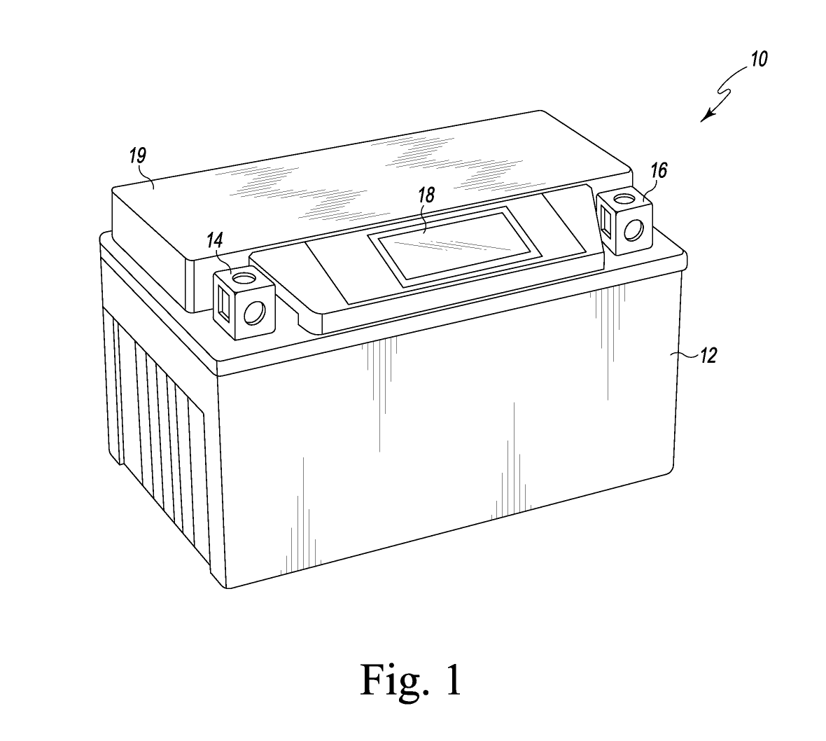

Referring to FIG. 1, a twelve (12) volt battery 10 is illustrated that can be used to power vehicles such as cars, motorcycles, off-road vehicles, and the like. Although a 12-volt battery is disclosed, it is envisioned that other battery voltage levels could be used in alternative embodiments. The battery 10 includes a case 12 that has a generally rectangular configuration. In one form, the case 12 is made from acrylonitrile butadiene styrene (ABS) but other plastic materials may be used in alternate forms. In this form, the case 12 is a sealed case that does not open so that the internal components of the battery 10 are not readily accessible to the user. A cap 19 is included on the top of the battery 10 that acts as a vent for any gas that may be produced by the battery 10.

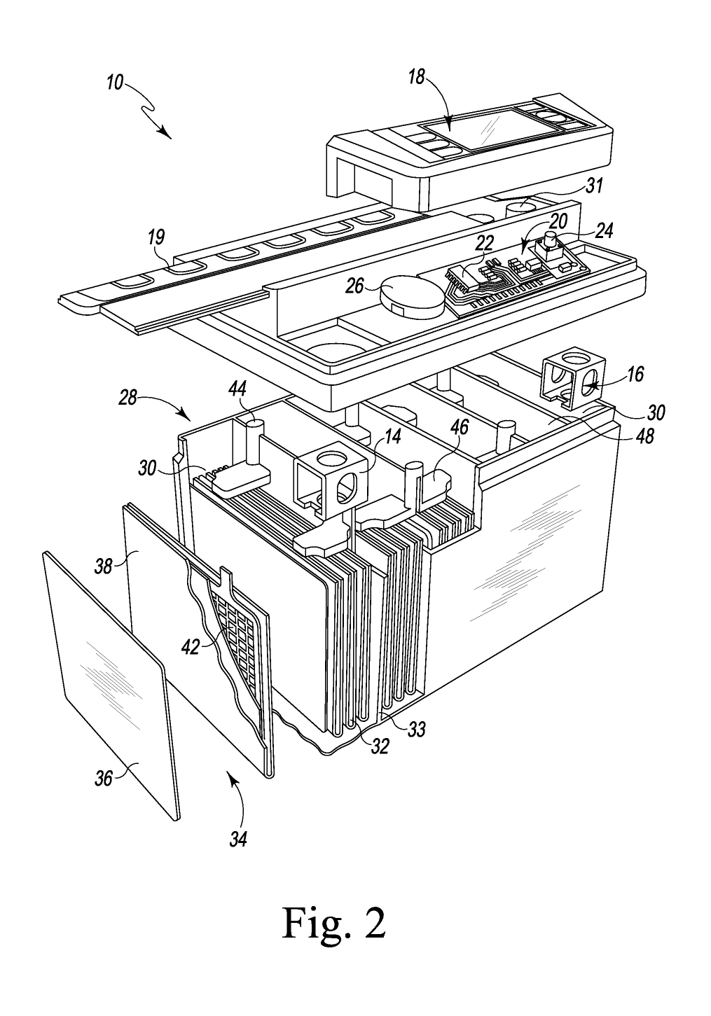

Protruding outwardly from the case 12 is a plated copper positive terminal 14 and a plated copper negative terminal 16. Mounted on top of the case 12 and powered by the battery 10 is a liquid crystal display (LCD) 18. Referring to FIG. 2, the internal components of the battery 10 are illustrated in greater detail. The LCD 18 is driven by and connected with a circuit board 20. The circuit board 20 includes a controller 22, a button 24, and a speaker or buzzer 26. The circuit board 20 is configured to monitor various conditions of the battery 100 and alert the user if a condition exists that is not normal or that may need attention.

The interior portion 28 of the battery is divided into six battery cell chambers 30 that each house or contain a battery cell 32. In the illustrated form, each battery cell 32 is comprised of three separate plate arrangements 34. The plate arrangements 34 comprise a Pb—Ca negative lead acid battery plate 36, an absorption glass matt (“AGM”) separator 38, a Pb—Ca positive lead acid battery plate 40, and an alloy grid 42. The AGM separator 38 has a U-shape and houses the Pb—Ca positive lead acid battery plate 40 and the alloy grid 42 thereby keeping them electrically insulated from the Pb—Ca negative lead acid battery plate 36.

A first or negative bridge welding unit 44 is used to electrically interconnect all of the Pb—Ca negative lead acid battery plates 36 together in series and then to the negative terminal 16. A second or positive bridge welding unit 46 is used to electrically interconnect all of the Pb—Ca positive lead acid battery plates 40 together in series and then to the positive terminal 14. The welding units 44, 46 span from cell 32 to cell 32 and up and over a portion of the battery chambers 30. The circuit board 20 is electrically connected with and powered by the cells 32 of the battery 10. As illustrated, under the cap 19 are a plurality of vents 31 associated with each cell 32 that allow any gas that may be produced to escape from the battery 10. As further illustrated, the case 12 includes a plurality of inner walls 33 that separate each of the cells 32.

In the preferred form, a gelified electrolyte (“GEL”) 48 is placed in each of the battery chambers 30 and surrounds each battery cell 32. The gelified electrolyte 48 has a silica additive that causes it to stiffen or set up. Unlike a traditional wet-cell lead-acid battery, this battery 10 does not have to be kept upright because the GEL stiffens and therefore won't leak out of the case 12 if the battery 10 tipped over. In addition, gel batteries eliminate the electrolyte evaporation, spillage (and subsequent corrosion issues) common to a wet-cell battery, and boast greater resistance to temperatures, shock, and vibration. In other forms, the separator 38 comprises a gelified electrolyte and is used in place of AGM.

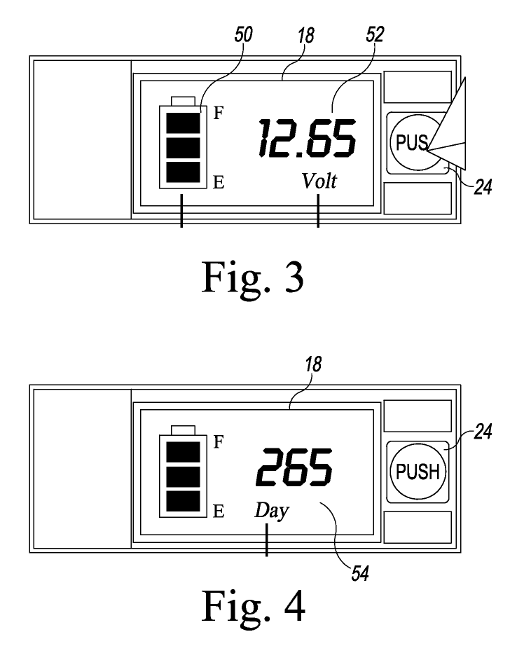

Referring to FIG. 3, the LCD 18 is operable to display a charge level state 50 and a voltage level state 52. The controller 22 drives the LCD 18 and causes it to display these readings from measurements the controller 22 takes from the battery 32. As shown in FIG. 4, pushing the button 24 can cause the LCD 18 to display a number of days indication 54 which is related to the amount of time the battery 10 has been installed. The controller 22 is also connected with the buzzer 26. The controller 22 is capable of activating the buzzer 26 in the event that the controller 22 senses an abnormal voltage level or a low voltage level capacity indication. The controller 22 is also capable of placing the battery 10 in a normal working mode, a power saving mode, and a rest mode. When installed in a vehicle, the battery 10 is configured to display a charging voltage that is being output by the alternator of the vehicle. For example, while the vehicle is running, the controller 22 will sense a charging voltage and the display will indicate a charging voltage such as, by way of example, a voltage level of about 13-14 V.

While the invention has been illustrated and described in detail in the drawings and foregoing description, the same is to be considered as illustrative and not restrictive in character, it being understood that only certain 20 exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A battery, comprising:
a sealed case;
a plurality of cells positioned in said sealed case;
a controller connected with and powered by said cells;
a display connected with said controller and mounted on said case; wherein said controller is configured to monitor at least one state of said battery, wherein said at least one state comprises a voltage level state of said battery; and
wherein said controller is configured to display said voltage level state on said display.

2. The battery of claim 1, wherein said display comprises a liquid crystal display.

3. The battery of claim 1, wherein said controller is configured to display a charge level state on said display.

4. The battery of claim 1, wherein said cells include a gelified electrolyte.

5. The battery of claim 1, wherein said case includes at least one vent associated with each said cell.

6. The battery of claim 1, wherein said controller is configured to display a number of days installed indication on said display.

7. The battery of claim 1, wherein said controller is connected with a sound emitting device, wherein said controller is configured to generate an alarm on said sound emitting device if the controller detects an error condition associated with said battery.

8. The battery of claim 7, wherein said error condition comprises an abnormal voltage level.

9. The battery of claim 7, wherein said error condition comprises a low voltage level capacity.

10. A battery, comprising:
a sealed case;
a plurality of cells positioned in said sealed case, wherein each said cell includes a plurality of Pb—Ca negative lead acid plates, a plurality of separators, a plurality of Pb—Ca positive lead acid plates, and a plurality of alloy grids, wherein said Pb—Ca negative lead acid plates are separated from said Pb—Ca positive lead acid plates by said separator, wherein said alloy grids are positioned adjacent said Pb—Ca positive lead acid plates;
a first bridge weld connected with each of said plurality of Pb—Ca negative lead acid plates and a negative terminal;
a second bridge weld connected with each of said plurality of Pb—Ca positive lead acid plates and a positive terminal;
a controller connected with and powered by said cells;
a display connected with said controller and mounted on said case;
wherein said controller is configured to monitor at least one state of said battery, wherein said at least one state comprises a voltage level state of said battery; and
wherein said controller is configured to display said voltage level state on said display.

11. The battery of claim 10, wherein said separators comprise an absorption glass matt separator.

12. The battery of claim 10, wherein said controller is configured to display a charge level state on said display.

13. The battery of claim 10, wherein said controller is connected with a sound emitting device, wherein said controller is configured to generate an alarm on said sound emitting device if the controller detects an error condition associated with said battery.

14. The battery of claim 10, wherein each of said cells is filled with a gelified electrolyte.

15. A battery, comprising:
a sealed case;
a plurality of cells positioned in said case, wherein each said cell includes a plurality of Pb—Ca negative lead acid plates, a plurality of Pb—Ca positive lead acid plates, and a plurality of alloy grids, wherein said Pb—Ca negative lead acid plates are separated from said Pb—Ca positive lead acid plates by a gelified gel, wherein said alloy grids are positioned adjacent said Pb—Ca positive lead acid plates;
a first bridge weld connected with each of said plurality of Pb—Ca negative lead acid plates and a negative terminal;
a second bridge weld connected with each of said plurality of Pb—Ca positive lead acid plates and a positive terminal;
a controller connected with and powered by said cells;
wherein said controller is configured to monitor at least one state of said battery, wherein said at least one state comprises a voltage level state of said battery; and
wherein said controller is configured to display said voltage level state on said display.

16. The battery of claim 15, wherein said controller is configured to display a charge level state on said display.

17. The battery of claim 15, wherein said controller is connected with a sound emitting device, wherein said controller is configured to generate an alarm on said sound emitting device if the controller detects an error condition associated with said battery.

18. The battery of claim 15, further comprising a separator surrounding said plurality of Pb—Ca positive lead acid plates and said plurality of alloy grids.

19. The battery of claim 18, wherein said separator comprises an absorption glass matt separator.

20. The battery of claim 19, wherein said separator has a generally U-shape configuration.
